(19) United States
(12) Patent Application Publication
(10) Pub. No.: US 2020/0354025 A1
(43) Pub. Date: Nov. 12, 2020

(54) FISHING TRAP HANDLING SYSTEM

(71) Applicant: OAKLEAF CRANE AND INSPECTION SERVICES LTD., Church Point (CA)

(72) Inventors: Vincent Joseph Stuart, Meteghan Centre (CA); Gary Donald Le Blanc, Saint Joseph (CA); Alex Stevenson, RR#3 Tusket (CA)

(73) Assignee: OAKLEAF CRANE AND INSPECTION SERVICES LTD., Church Point (CA)

(21) Appl. No.: 16/870,608

(22) Filed: May 8, 2020

(30) Foreign Application Priority Data
May 9, 2019 (CA) 3042783

(51) Int. Cl. B63B 27/10; A01K 69/06; B63B 27/16; B63B 35/20

(52) U.S. Cl. CPC B63B 27/10; B63B 35/20; B63B 27/16; A01K 69/06

(57) ABSTRACT

A fishing trap handling system for handling fishing traps on a deck of a fishing vessel is provided. The fishing trap handling system comprises a gantry crane type lifting apparatus for being mounted to the fishing vessel. The lifting apparatus is adapted for operation while the fishing vessel is exposed to rough seas. An end effector is mounted to a hoist of the lifting apparatus. The end effector is adapted for easily engaging one of the fishing traps and for holding the fishing trap in a substantially horizontal orientation.

### FIELD OF THE INVENTION

The present invention relates to handling systems, and more particularly to a fishing trap handling system for handling fishing traps such as, for example, lobster traps and crab traps, on the deck of a fishing vessel.

### BACKGROUND OF THE INVENTION

Presently, fishing traps such as, for example, lobster traps and crab traps, are manually moved on deck of a fishing vessel between a storage location, where, typically, a considerable number of fishing traps are stacked, to a landing location on the gunwale of the fishing vessel, where the fishing traps are lowered to the seafloor or hauled back therefrom.

To provide greater yields and to reduce trap movement on the seafloor in rough seas, fishing traps have been made bigger and heavier over the years. The increased size and weight of the fishing traps make manual handling increasingly difficult and hazardous, in particular when the work has to be done in rough seas, and put a substantial strain on a fisherman's body.

It is desirable to provide a fishing trap handling system for facilitating handling of fishing traps on deck of a fishing vessel.

It is also desirable to provide a fishing trap handling system for facilitating handling of fishing traps on deck of a fishing vessel that is operable when the handling is done in rough seas.

It is also desirable to provide a fishing trap handling system comprising an end effector that is easily engaged with the fishing trap and is capable of holding the fishing trap in a substantially horizontal orientation.

### SUMMARY OF THE INVENTION

Accordingly, one object of the present invention is to provide a fishing trap handling system for facilitating handling of fishing traps on deck of a fishing vessel.

Another object of the present invention is to provide a fishing trap handling system for facilitating handling of fishing traps on deck of a fishing vessel that is operable when the handling is done in rough seas.

Another object of the present invention is to provide a fishing trap handling system comprising an end effector that is easily engaged with the fishing trap and is capable of holding the fishing trap in a substantially horizontal orientation.

According to one aspect of the present invention, there is provided a fishing trap handling system for handling fishing traps on a deck of a fishing vessel. The fishing trap handling system comprises a gantry crane type lifting apparatus for being mounted to the fishing vessel. The lifting apparatus is adapted for operation while the fishing vessel is exposed to rough seas. An end effector is mounted to a hoist of the lifting apparatus. The end effector is adapted for easily engaging one of the fishing traps and for holding the fishing trap in a substantially horizontal orientation.

According to the aspect of the present invention, there is provided a fishing trap handling system for handling fishing traps on a deck of a fishing vessel. The fishing trap handling system comprises a gantry crane type lifting apparatus for being mounted to the fishing vessel. The lifting apparatus is adapted for operation while the fishing vessel is exposed to rough seas. An end effector is mounted to a hoist of the lifting apparatus. The end effector is adapted for easily engaging one of the fishing traps and for holding the fishing trap in a substantially horizontal orientation. End trucks of the lifting apparatus are driven using a continuous loop rope and a two-drum drive.

According to the aspect of the present invention, there is provided a fishing trap handling system for handling fishing traps on a deck of a fishing vessel. The fishing trap handling system comprises a gantry crane type lifting apparatus for being mounted to the fishing vessel. The lifting apparatus is adapted for operation while the fishing vessel is exposed to rough seas. An end effector is mounted to a hoist of the lifting apparatus. The end effector is adapted for easily engaging one of the fishing traps and for holding the fishing trap in a substantially horizontal orientation. The end effector comprises a safety switch and a hoist control button disposed thereon such that the safety switch is engaged by holding the end effector during handling while simultaneously enabling manipulation of the hoist control button.

According to the aspect of the present invention, there is provided a fishing trap handling system for handling fishing traps on a deck of a fishing vessel. The fishing trap handling system comprises a gantry crane type lifting apparatus for being mounted to the fishing vessel. The lifting apparatus is adapted for operation while the fishing vessel is exposed to rough seas. An end effector is mounted to a hoist of the lifting apparatus. The end effector is adapted for easily engaging one of the fishing traps and for holding the fishing trap in a substantially horizontal orientation. The end effector comprises a hoist arm mounted to the hoist and a fishing trap engaging arm. The fishing trap engaging arm has a cross section smaller than a mesh size of the fishing trap for enabling insertion of the same through a top mesh of a side wall thereof. The fishing trap engaging arm is placed a predetermined angle to the hoist arm such that during handling the fishing trap is oriented substantially horizontally.

According to the aspect of the present invention, there is provided a fishing trap handling system for handling fishing traps on a deck of a fishing vessel. The fishing trap handling system comprises a gantry crane type lifting apparatus for being mounted to the fishing vessel. The lifting apparatus is adapted for operation while the fishing vessel is exposed to rough seas. An end effector is mounted to a hoist of the lifting apparatus. The end effector is adapted for easily engaging one of the fishing traps and for holding the fishing trap in a substantially horizontal orientation. The end effector comprises a hoist arm mounted to the hoist and a fishing trap engaging plate connected to the hoist arm. The fishing trap engaging plate has hooks for engaging a top edge of a side wall of the fishing trap and is of sufficient size for abutting the side wall.

The advantage of the present invention is that it provides a fishing trap handling system for facilitating handling of fishing traps on deck of a fishing vessel.

A further advantage of the present invention is that it provides a fishing trap handling system for facilitating handling of fishing traps on deck of a fishing vessel that is operable when the handling is done in rough seas.

A further advantage of the present invention is that it provides a fishing trap handling system comprising an end effector that is easily engaged with the fishing trap and is capable of holding the fishing trap in a substantially horizontal orientation.

### BRIEF DESCRIPTION OF THE DRAWINGS

A preferred embodiment of the present invention is described below with reference to the accompanying drawings, in which:

FIG. 1a is a simplified block diagram illustrating in a perspective view a fishing trap handling system according to a preferred embodiment of the invention;

FIGS. 1b and 1c are simplified block diagrams illustrating in a perspective view and a side view, respectively, an end truck of the fishing trap handling system according to the preferred embodiment of the invention;

FIG. 1d is a simplified block diagram illustrating in a perspective view a commercially available car/rail system employed in the fishing trap handling system according to the preferred embodiment of the invention;

FIGS. 1e to 1g are simplified block diagrams illustrating in a top perspective view, a side perspective view, and a top view, respectively, a continuous loop rope drive system of the fishing trap handling system according to the preferred embodiment of the invention;

FIGS. 2a to 2c are simplified block diagrams illustrating in a top front perspective view, a top side perspective view, and a bottom perspective view, respectively, a trolley of the fishing trap handling system according to the preferred embodiment of the invention;

FIG. 2d is a simplified block diagram illustrating movement of the trolley using an angle sensor employed in the fishing trap handling system according to the preferred embodiment of the invention;

FIG. 3a is a simplified block diagram illustrating in a side view a first embodiment of an end effector of the fishing trap handling system according to the preferred embodiment of the invention;

FIGS. 3b and 3c are simplified block diagrams illustrating in perspective views a second end effector of the fishing trap handling system according to the preferred embodiment of the invention;

FIGS. 3d and 3e are simplified block diagrams illustrating in perspective views a third end effector of the fishing trap handling system according to the preferred embodiment of the invention;

FIGS. 3f to 3h are simplified block diagrams illustrating in perspective views a locking mechanism of the third end effector of the fishing trap handling system according to the preferred embodiment of the invention; and,

FIG. 3i is a simplified block diagram illustrating in a cross-sectional view a release mechanism of the third end effector of the fishing trap handling system according to the preferred embodiment of the invention.

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

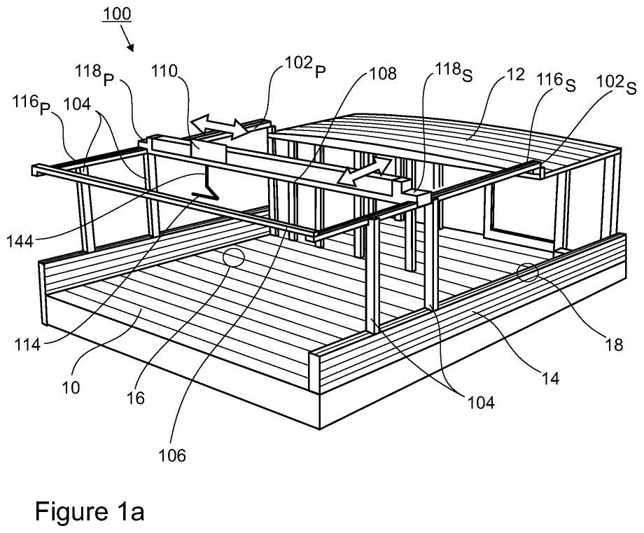

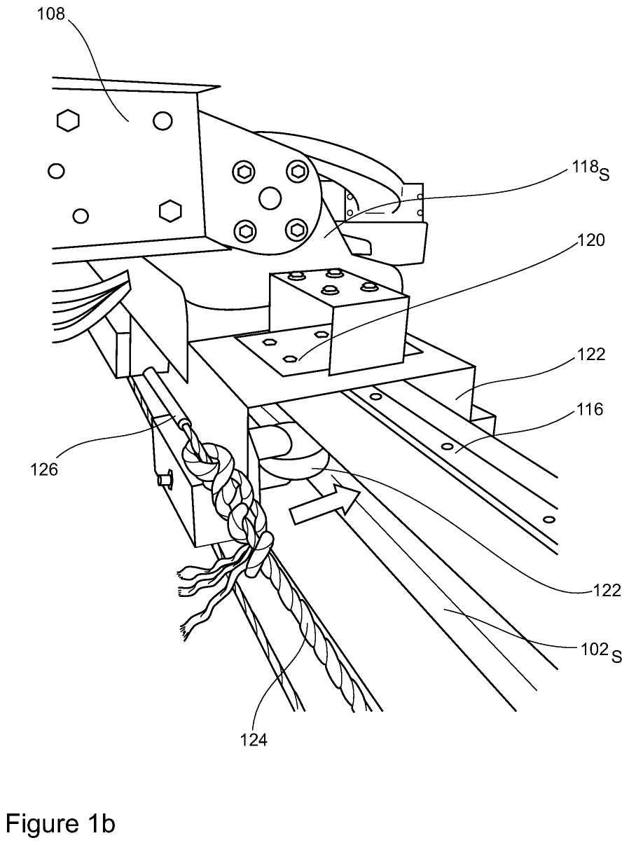

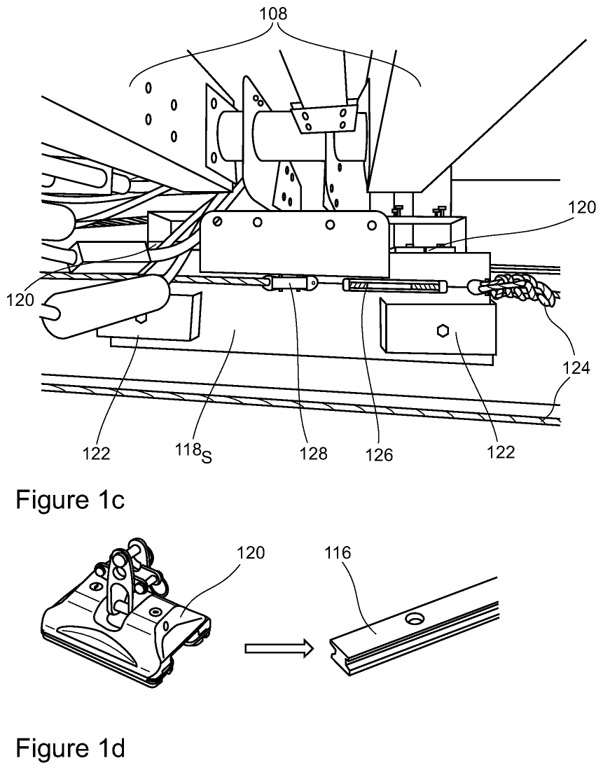

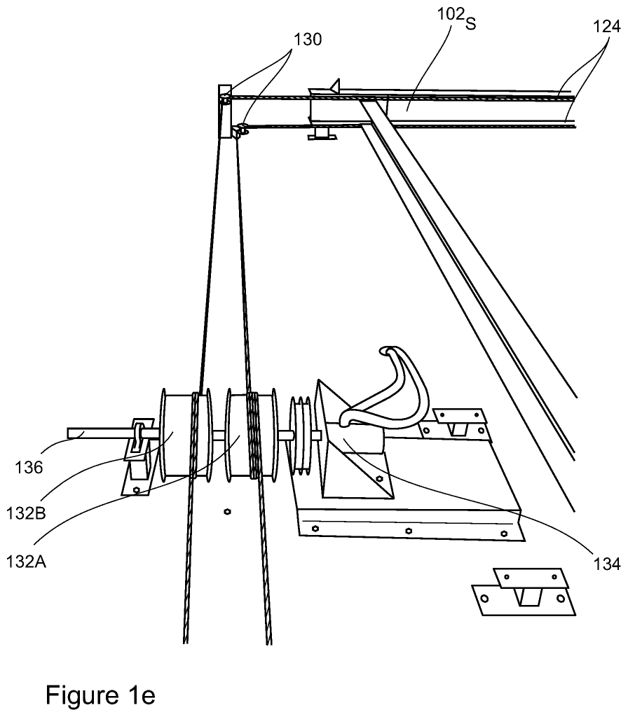

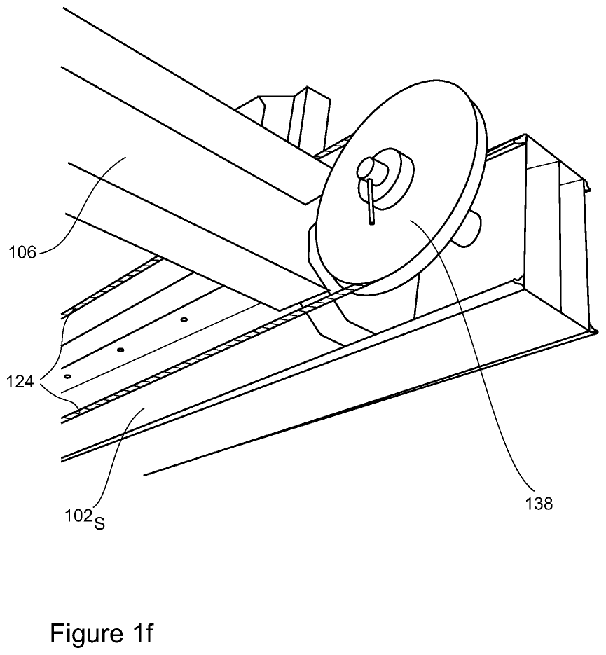

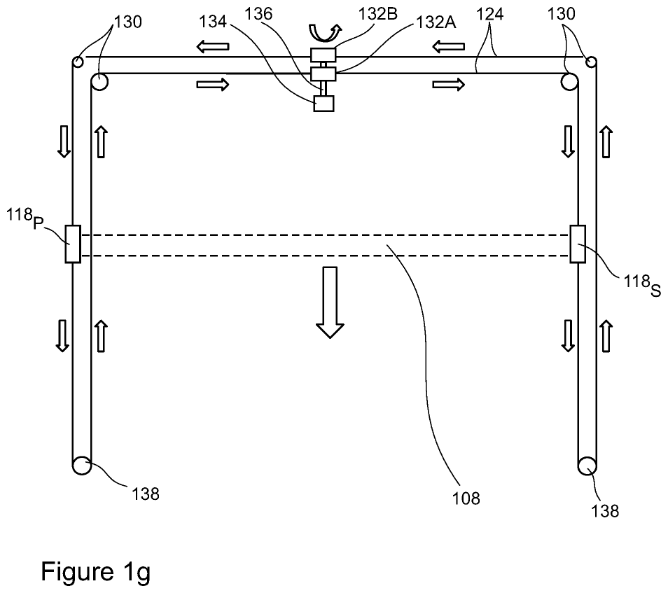

Referring to FIGS. 1a to 3c a fishing trap handling system 100 according to a preferred embodiment of the invention is provided. The fishing trap handling system 100 comprises a gantry crane type lifting apparatus mounted to, for example, a stern portion of a fishing vessel, which is adapted for operation while the fishing vessel is exposed to rough seas. Starboard and port runway beams 102S, 102P are placed a predetermined distance above the deck 10 and oriented in fore to aft direction substantially parallel to respective gunwales 14 of the fishing vessel. The runway beams 102S, 102P are mounted to the deck 10 and/or the gunwales 14 via support posts 104. Furthermore, the runway beams 102S, 102P are mounted to a rear end portion of the wheelhouse 12 of the fishing vessel or, alternatively, via additional support posts to the deck 10 and/or the gunwales 14. The rear end portions of the runway beams 102S, 102P are connected via rear end beam 106 to ensure structural integrity and parallel orientation of the runway beams 102S, 102P. Runway rails 116S, 116P are disposed onto a respective top surface of each of the runway beams 102S, 102P. Starboard and port end trucks 118S, 118P, mounted to bridge girders 108, are movable connected to the respective runway rails 116S, 116P. The bridge girders 108 movably support trolley 110 with hoist 144 having end effector 114 mounted thereto. The hoist 144 is movable in fore/aft direction as well as in port/starboard direction, as indicated by the block arrows in FIG. 1a, enabling movement of the fishing traps on deck 10, for example, between a storage location 16 and a landing location 18, as well as stacking/removal from a stack of the fishing traps.

In order for the lifting apparatus to be operable in rough seas, the end trucks 118S, 118P are secured to the runway rails 116S, 116P such that reliable movement of the end trucks 118S, 118P along the runway rails 116S, 116P is enabled while the lifting apparatus is exposed to horizontal as well as vertical movement by employing, for example, a commercially available car/rail system used for the rigging of sailboats such as the HARKEN® car 120/rail 116 system, as illustrated in FIGS. 1b to 1d. Spring loaded side casters 122 are mounted to the end trucks 118S, 118P such that they are disposed on opposite sides of the respective runway beam 102S, 102P and in contact with respective side surfaces thereof, as indicated by the block arrow in FIG. 1b, in order to prevent binding of the end trucks 118S, 118P when moved along the runway rails 116S, 116P in rough seas.

The end trucks 118S, 118P are driven using rope 124, mounted to rope mount 128 of each of the end trucks 118S, 118P, with the rope 124 forming a continuous loop driven by a two-drum 132A, 132B drive system, as illustrated in FIGS. 1e to 1g. Both drums 132A, 132B are mounted to axle 136 driven by drive 14, for example, a commercially available hydraulic drive mechanism, thus both drums 132A, 132B turn in the same direction. The rope 124 is wrapped around each of the drums 132A, 132B, for example, 2 complete wraps, with the direction of movement of the rope 124 being reversed by having the rope 124 wrapped around the drums in opposite direction. The rope is guided to/from the drums 132A, 132B via guide wheels 130 and return wheels 138. Using the continuous loop rope 124 and the two-drum 132A, 132B drive substantially prevents uneven movement of the end trucks 118S, 118P, as illustrated in FIG. 1g. Using a conventional tensioning mechanism 126 the tensioning of the rope 124, for example, commercially available Dyneema® rope, is adjusted such that the end trucks 118S, 118P, are driven by turning the drums 132A, 132B while also providing a clutch effect when the end trucks 118S, 118P start to bind during movement by enabling the rope 124 to slip on the drums 132A, 132B.

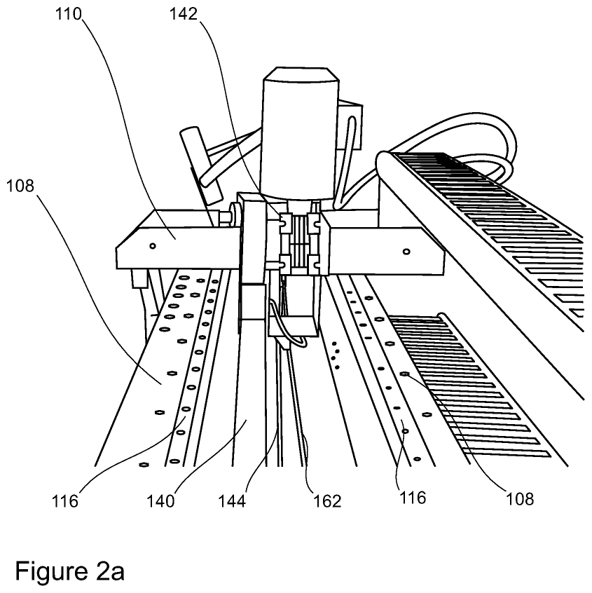

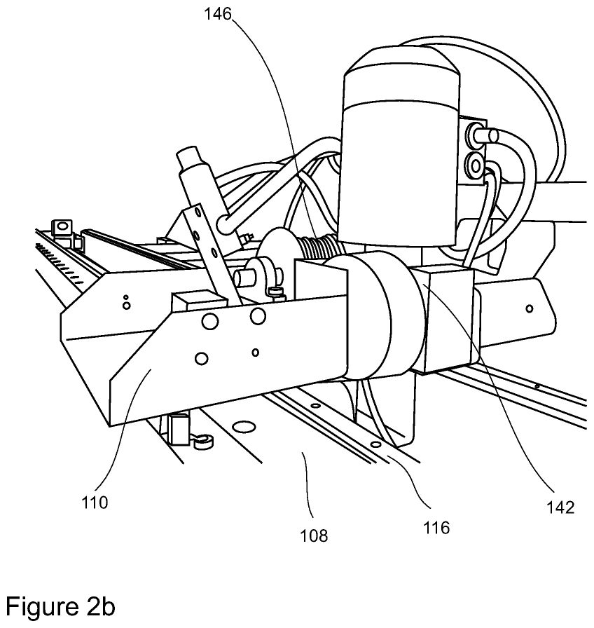

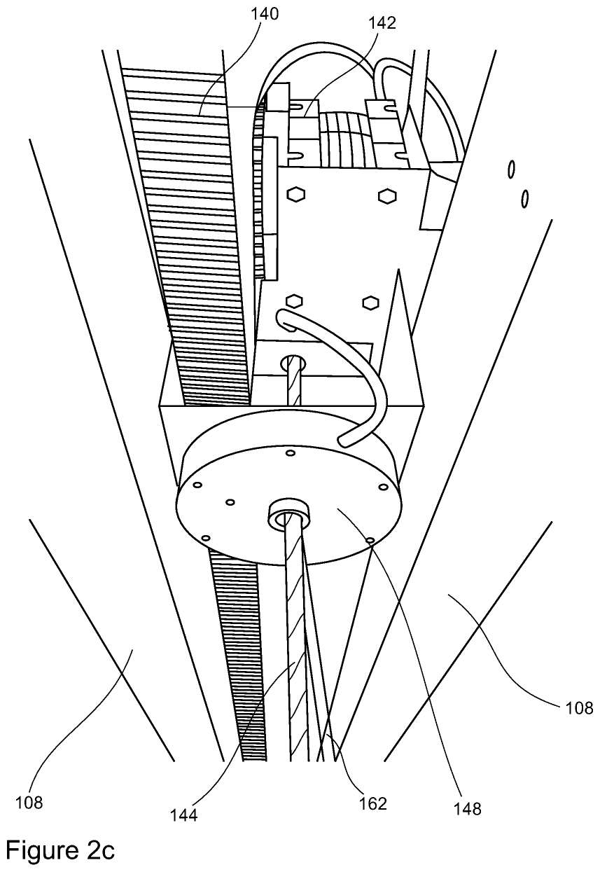

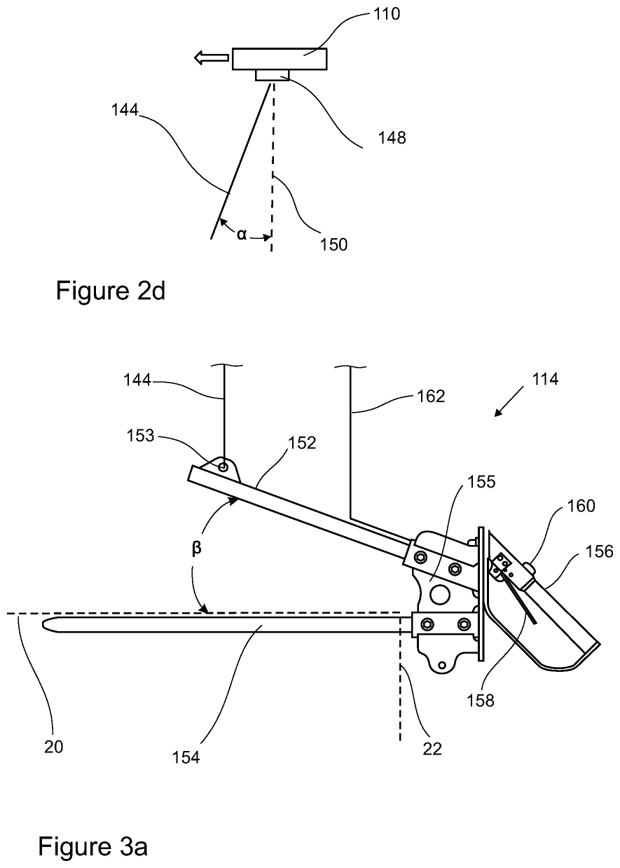

Similarly to the end trucks 118S, 118P, reliable movement of the trolley 110 on the bridge girders 108 during rough seas is enabled by employing, for example, the HARKEN® car 120/rail 116 system, as illustrated in FIGS. 2a and 2b. The trolley 110 comprises winch 146 connected, for example, to a hydraulic drive, for lifting/lowering the hoist 144. The trolley 110 is driven using, for example, a commercially available toothed belt 140 drive system driven by electric motor 142. Alternatively, the drive system is omitted and the trolley 110 is moved manually by pushing the hoist 144.

Movement of the trolley 110 and the end trucks 118S, 118P, is controlled via angle sensor 148, which measures the angle α between the hoist 144 and the vertical 150 in the for/aft direction and the port/starboard direction, as illustrated in FIGS. 2c and 2d. Once the hoist is pushed in a certain direction, the angle sensor provides a signal indicative of the angle α to a controller which in turn activates the electric motor 142 and the hydraulic drive 134 to move the trolley 110 and the end trucks 118S, 118P such that the trolley 110 is moved in the direction the hoist 144 has been pushed, as indicated by the block arrow in FIG. 2d, until the hoist 144 is oriented approximately vertical. Employment of the angle sensor 148 substantially facilitates operation of the lifting apparatus by enabling control of the movement of the trolley 110 by simply pushing the hoist 144 in a desired direction. Cable 162 transmits signals from safety switch 158 and hoist control button 160 disposed on the handle 156 of the end effector 114 to the controller. The hoist control button 160 enables lifting/lowering of the hoist 144 while holding the end effector 114. Movement of the hoist 144 and the trolley 110 is only enabled when the safety switch 158 is activated. Furthermore, if the safety switch 158 has not been activated a conventional breaking mechanism locks the trolley 110 in the current position. Optionally, once the safety switch 158 has been released the hoist 144 is slowly lowered to the deck 10 to avoid a ‘wrecking ball’ effect on deck when in rough seas. Further optionally, once the safety switch 158 has been released the trolley 110 is moved to a predetermined ‘home’ location such as, for example, the landing location 18.

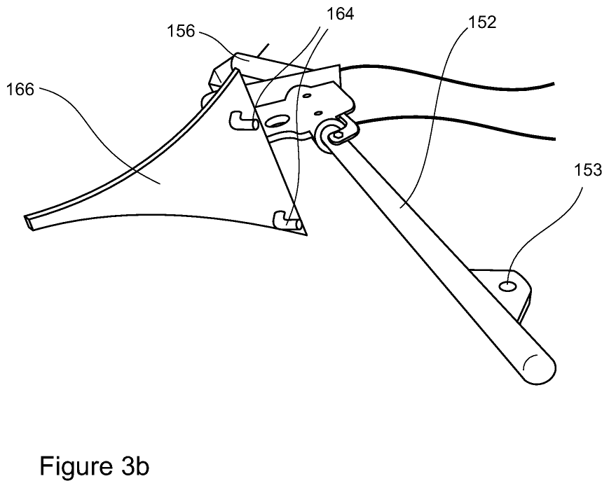

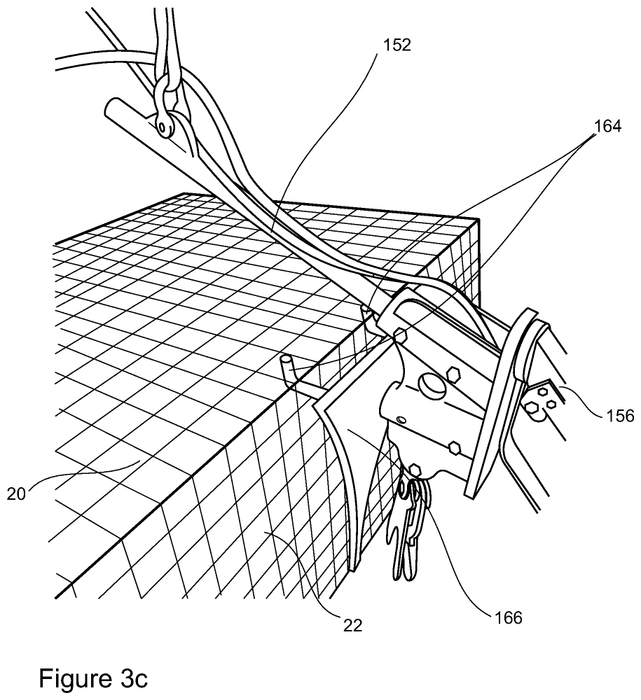

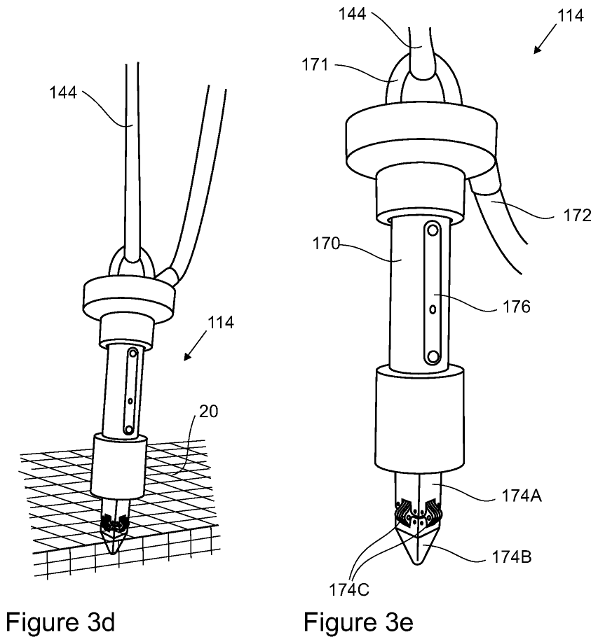

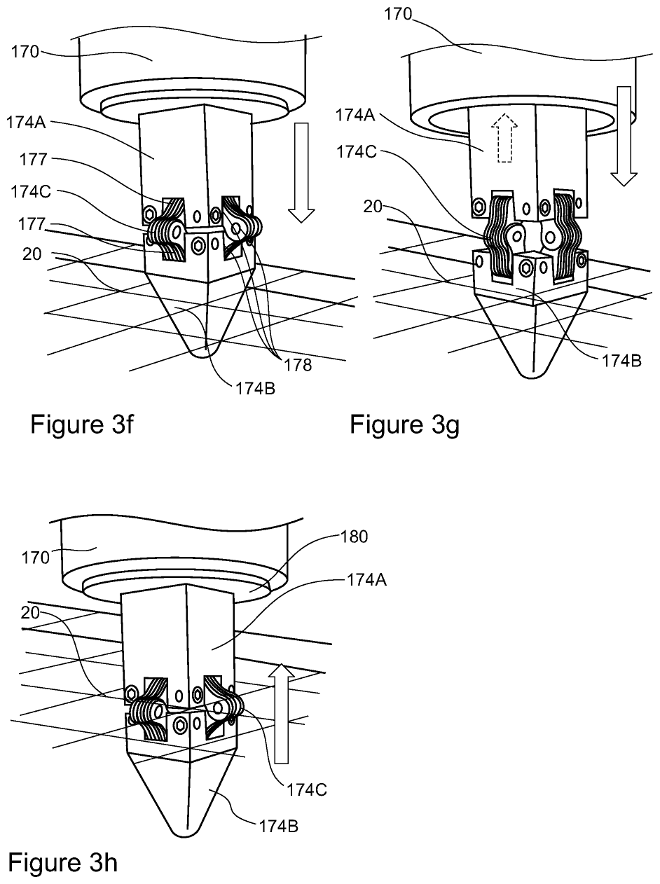

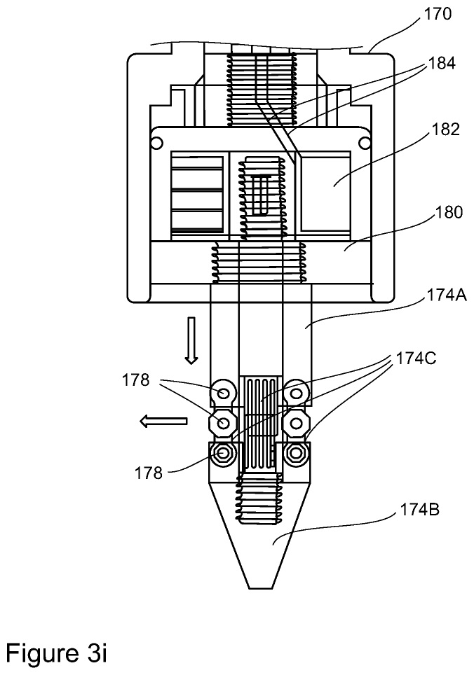

The end effector 114, as illustrated in FIG. 3a, comprises hoist arm 152 connected to fishing trap engaging arm 154 via connecting element 155. The fishing trap engaging arm 154 comprises, for example, a straight rod having a circular cross section smaller than the mesh size of the fishing trap for enabling insertion of the same through a top mesh of side wall 22 (in proximity to the middle of the same) of the fishing trap and for engaging top wall 20 of the fishing trap during handling of the same. The hoist arm 152 is mounted to the hoist 144 at hoist mounting element 153. The end effector 114 further comprises handle 156 mounted to the connecting element 155. Safety switch 158 is placed such that the same is easily activated when the handle 156 is held by the operator, while at a same time the operator can manipulate the hoist control button 160 for lifting/lowering the end effector 114 with his thumb. The safety switch 158 and the hoist control button 160 are connected to the controller via cable 162. Preferably, the fishing trap engaging arm 154 is placed at a predetermined angle θ to the hoist arm 152 such that during handling the fishing trap is oriented substantially horizontally, thus providing proper balance of the fishing trap while also enabling a full range of motion for stacking/removal.

Optionally, indentations are disposed on the top of the fishing trap engaging arm 154 for engaging the mesh of the top wall 20 during handling, thus preventing slipping of the fishing trap engaging arm 154. Further optionally, two or more fishing trap engaging arms 154 oriented parallel to each other are provided forming a fork-like structure for engaging the top wall 20.

Alternatively, the fishing trap engaging arm 154 is replaced by fishing trap engaging plate 166 and hooks 164, as illustrated in FIGS. 3b and 3c. The hooks 164 are designed for engaging the top edge of the side wall 22 (in proximity to the middle of the same) while the fishing trap engaging plate 166 is of sufficient size for abutting the side wall 22 during handling of the fishing trap.

Referring to FIGS. 3d to 3i, another implementation of the end effector 114 of the fishing trap handling system 100 is provided. Here, locking mechanism mounted to a bottom end of the end effector 114 is designed to slide through the top mesh 20 of the fishing trap, preferably, into a top bridge mesh near a center of gravity of a wire trap. The locking mechanism is then locked to the top mesh 20 of the fishing trap, as illustrated in FIG. 3d. The end effector 114 comprises housing 170 which is mounted at a top end thereof to the hoist 144 via hanging bracket 171. Movement of the hoist 144 is controlled via control 176 connected to the controller via cable 172. Furthermore, control 176 enables control of the operation of the end effector 114. Peg-lock nose 174B is fixedly mounted to a bottom portion of the housing 170. Peg-lock link body 174A, disposed between the peg-lock nose 174B and the bottom portion of the housing 170, is vertically movable with respect to the peg-lock nose 174B. The bottom end of the peg-lock link body 174A is connected to the top end of the peg-lock nose 174B via chain link 174C. The chain link 174C comprises chain elements 177 which are pivotally movable about pivots 178.

In operation, the end effector 114 is moved downwardly towards the top mesh 20 of the fishing trap such that a tip portion of the peg-lock nose 174B is moved through one mesh opening of the top mesh 20, as indicated by the block arrow in FIG. 3f When the chain link 174C protruding outwardly from the peg-lock nose 174B, comes in contact with the top mesh 20, the chain link 174C and the peg-lock link body 174A connected thereto is pushed upwardly, as indicated by the dashed block arrow in FIG. 3g, until the chain link 174C is moved through the top mesh 20. After being moved through the top mesh 20, the chain link 174C and the peg-lock link body 174A fall back down with the chain link 174C protruding a sufficient distance for securely locking the end effector 114 to the top mesh 20 during lifting, as indicated by the block arrow in FIG. 3h.

FIG. 3i illustrates a preferred release mechanism of the end effector 114. The release mechanism comprises coil pull plate 180 mounted to the top end of the peg-lock link body 174A and lock release electric coil 182 disposed in the bottom portion of the housing 170. After provision of electrical power via wiring 184 connected to control 176, the coil pull plate 180 is pulled upwardly together with the peg-lock link body 174A and the chain link 174C connected thereto, thus enabling movement of the chain link 174C through the top mesh 20 for releasing the end effector 114.

Optionally, the control 176, in concert with the controller, is adapted to enable operation of the end effector 114 as follows:

pressing a start button of the fishing trap handling system 100 causes lowering of the end effector 114 until the same is lowered automatically, using a timer, to approximately operator shoulder's height;

the operator takes hold of the housing 170 of the end effector 114 and pulls down the control 176 causing lowering of the end effector 114 towards the fishing trap;

the operator puts the peg-lock nose 174B and the chain link 174C through an opening of the fishing trap wire mesh 20 and then pulls up the control 176 causing lifting of the end effector 114 and the fishing trap after chain link 174C is in contact with the fishing trap wire mesh 20;

the operator continues pulling up the control 176 until the desired height is reached and then moves the control 176 into middle position causing the lifting to stop;

the operator then releases the control 176 causing automatically lowering of the end effector 114; and,

when the fishing trap is in contact with the floor, the weight of the end effector 114 pushing onto the trap mesh 20 activates the upward position switch of control 176 applying power to the lock release electric coil 182 causing the coil pull plate 180 being pulled upwardly together with the peg-lock link body 174A and the chain link 174C connected thereto and causing automatically lifting, using a timer, of the end effector 114 to the top home position.

The fishing trap handling system 100 substantially facilitates handling of fishing traps on deck of a fishing vessel in rough seas by providing: an end effector that is easily engaged with the fishing trap; an end effector that is capable of holding the fishing trap in a substantially horizontal orientation; simple operation of the hoist with the hand holding the end effector; and, simple operation of the trolley by pushing the hoist in the desired direction.

In an example implementation the fishing trap handling system 100 has been adapted for being mounted to the stern portion of a fishing vessel behind the wheelhouse with the lifting apparatus covering a 24′×24′ deck size and having a height above the deck of approximately 9′. The lifting apparatus is made of commercially available aluminum profiles such as square-profiles and I-profiles using conventional manufacturing technologies such as welding and screw fastening.

The present invention has been described herein with regard to preferred embodiments. However, it will be obvious to persons skilled in the art that a number of variations and modifications can be made without departing from the scope of the invention as described herein.

What is claimed is:

1. A fishing trap handling system for handling fishing traps on a deck of a fishing vessel comprising:
a gantry crane type lifting apparatus for being mounted to the fishing vessel, the lifting apparatus being adapted for operation while the fishing vessel is exposed to rough seas; and,
an end effector mounted to a hoist of the lifting apparatus, the end effector being adapted for easily engaging one of the fishing traps and for holding the fishing trap in a substantially horizontal orientation.

2. The fishing trap handling system according to claim 1 wherein the lifting apparatus comprises:
starboard and port runway beams oriented in fore to aft direction substantially parallel to respective gunwales of the fishing vessel;
runway rails disposed onto a respective top surface of each of the runway beams;
starboard and port end trucks movable connected to the respective runway rails;
bridge girders mounted to the starboard and port end trucks;
a support trolley movable connected to the bridge girders; and,
a hoist mounted to the support trolley.

3. The fishing trap handling system according to claim 2 wherein end trucks are driven using a continuous loop rope and a two-drum drive.

4. The fishing trap handling system according to claim 2 wherein the end trucks are vertically secured to the respective runway rails.

5. The fishing trap handling system according to claim 2 wherein each end truck comprises spring loaded side casters such that they are disposed on opposite sides of the respective runway beam and in contact with respective side surfaces thereof.

6. The fishing trap handling system according to claim 2 wherein each of the bridge girders comprises a runway rail disposed onto a respective top surface thereof.

7. The fishing trap handling system according to claim 6 wherein the support trolley is vertically secured to the runway rails.

8. The fishing trap handling system according to claim 1 wherein the end effector comprises a safety switch and a hoist control button disposed thereon such that the safety switch is engaged by holding the end effector during handling while simultaneously enabling manipulation of the hoist control button.

9. The fishing trap handling system according to claim 1 wherein the end effector comprises a hoist arm mounted to the hoist and a fishing trap engaging arm, the fishing trap engaging arm having a cross section smaller than a mesh size of the fishing trap for enabling insertion of the same through a top mesh of a side wall thereof, and wherein the fishing trap engaging arm is placed a predetermined angle to the hoist arm such that during handling the fishing trap is oriented substantially horizontally.

10. The fishing trap handling system according to claim 1 wherein the end effector comprises a hoist arm mounted to the hoist and a fishing trap engaging plate connected to the hoist arm, the fishing trap engaging plate having hooks for engaging a top edge of a side wall of the fishing trap and being of sufficient size for abutting the side wall.

11. The fishing trap handling system according to claim 1 wherein the end effector comprises:
a housing mounted to the hoist at a top end thereof; and,
a locking mechanism mounted to a bottom end of the housing, the locking mechanism being adapted for sliding through a top mesh of the fishing trap and locking thereto.
